(19) United States
(12) Patent Application Publication
(10) Pub. No.: US 2003/0055863 A1
(43) Pub. Date: Mar. 20, 2003

(54) Method and apparatus for managing system resources in an information handling system

(76) Inventors: Michael G. Spiegel, Monroe, NY (US); Ernest S. Bender, Saugerties, NY (US); Lisa Jane Noval, Clinton Corners, NY (US); Bernd Jostmeyer, Holzgerlingen (DE)

Correspondence Address: IBM Corporation, 2455 South Road M/S P386, Poughkeepsie, NY, 12601, US

(21) Appl. No.: 09/912,193

(22) Filed: Jul. 24, 2001

(51) Int. Cl. G06F 9/00

(52) U.S. Cl. 709/104

(57) ABSTRACT

A method and apparatus for managing a resource in an information handling system in which one or more processes are utilizing the resource. The current utilization of the resource is determined and compared with a predetermined maximum utilization set for the resource, either for the system as a whole or for a particular process executing on the system. A message is generated if the current utilization of the resource reaches any one of a plurality of predetermined fractional thresholds relative to the predetermined maximum utilization set for the resource. An operator command allows the messages to be displayed for all resources or just for system-wide resources, or to be suppressed entirely. Another operator command allows the operator to obtain a display of current resource utilization, the peak (“high water”) utilization since the last reset, and the maximum resource utilization, either for the system as a whole or for a particular process. Yet another operator command allows the operator to change a usage limit for a particular process without affecting other processes.

### BACKGROUND OF THE INVENTION

1. Field of the Invention

This invention relates to a method and apparatus for managing resources in an information handling system. More particularly, it relates to such a method and apparatus for managing system resources in a UNIX-based system.

2. Description of the Related Art

UNIX-based operating systems are used on a number of computer hardware platforms, especially for server applications but for client applications as well. (“UNIX-based” means here that an operating system performs all or a substantial portion of a standard set of UNIX functions, whether or not the software is derived from a UNIX code base or is branded as a UNIX system.) UNIX-based systems include such operating systems as Linux, an open-source offering used on multiple hardware platforms; AIX, an IBM operating system used primarily on the IBM RS/6000 and pSeries hardware platforms; and OS/390 and z/OS with their UNIX System Services components, IBM operating systems used on the IBM S/390 and eServer zSeries hardware platforms. (UNIX is a registered trademark of The Open Group in the United States and other countries; Linux is a registered trademark of Linus Torvalds; AIX, RS/6000, pSeries, OS/390, z/OS, S/390, and zSeries are trademarks or registered trademarks of IBM Corporation.)

The UNIX System Services components of OS/390 and z/OS are configured, as are other UNIX-based operating systems, by setting a number of parameters during initialization. These parameters can then be changed via operator command while the system is running. The parameters can be divided into two categories:

1. System limits, which affect all UNIX processes and users of UNIX System Services. Examples of such system limits in UNIX System Services include MAXPROCSYS, MAXUIDS, MAXPTYS, SHRLIBRGNSIZE, and IPCMSGNIDS, described below.

2. Process limits, which limit resources for each process. The value is set at initialization and is applied to each process. Examples of such process limits include MAXFILEPROC, MAXTHREADS, MAXFILESIZE, and IPCMSGQBYTES, also described below.

In the prior art, it was difficult for installations to determine when UNIX System Services resources were reaching critical levels, and it was difficult to manage the values for these resources. Although most of the system limits could be changed during operations, the changes had no effect on currently running processes. This meant that long-running applications had to be stopped and then restarted to pick up the changes. Also, for process-level limits, the change applied to all processes, not just one process.

### SUMMARY OF THE INVENTION

The present invention relates generally to a method and apparatus for managing a resource in an information handling system in which one or more processes are utilizing the resource.

In accordance with one aspect of the present invention, the current utilization of the resource is determined and compared with a predetermined maximum utilization set for the resource, either for the system as a whole or for a particular process executing on the system. A message is generated if the current utilization of the resource reaches any one of a plurality of predetermined fractional thresholds relative to the predetermined maximum utilization set for the resource. Preferably, an operator command (SETOMVS LIMMSG= in the disclosed embodiment) allows the messages to be displayed for all resources (LIMMSG=ALL) or just for system-wide resources and certain process-level resources (LIMMSG=SYSTEM), or to be suppressed entirely (LIMMSG=NONE).

Another aspect of the present invention relates to an operator command (D OMVS,L) that allows the operator to obtain a display of current resource utilization, the peak (“high water”) utilization since the last reset, and the maximum resource utilization, either for the system as a whole or (by using the keyword PID=) for a particular process. More particularly, this aspect of the invention relates to a method and apparatus for managing a resource in an information handling system in which a plurality of processes executing on the system are utilizing the resource. In accordance with this aspect of the invention, in response to receiving an external command for the display of the current utilization of the resource by a specified process, a display is generated of the current utilization of the resource by the specified process. The display may show the current utilization of each of a plurality of resources by the specified processes, and may also show a predetermined maximum utilization set for each resource, as well as the maximum actual utilization of each resource over a predetermined period.

Yet another aspect of the present invention relates to an operator command (SET OMVS PID=) that allows the operator to change a usage limit for a particular process without affecting other processes. This aspect of the invention likewise relates to a method and apparatus for managing a resource in an information handling system in which a plurality of processes executing on the system are utilizing the resource. In accordance with this aspect of the invention, in response to receiving an external command specifying a maximum utilization of the resource by a specified process, the maximum utilization of the resource by the specified process is set as specified by the command, independently of any other process executing on the system.

The present invention monitors system resources at both the system-wide level and the UNIX process level. It also enables operators to choose which process, task, or unit of work to allocate the most resources to and to dynamically change that limit.

This new function provides an installation the ability to monitor and manage UNIX System Services resources through operator messages and commands.

The invention provides the means for an installation to manage system resources in a more automated and more granular manner than previously possible in the prior art. Prior to this invention, system resources could not be automatically managed at as granular a level, thus causing potential disruption to a customer's workload when a particular resource limit was reached by a particular unit of work. Although the invention is not limited to the management of UNIX resources, it has particular application to the management of UNIX-based resources and achieves a major advantage over other UNIX platforms that do not have the capability to dynamically manage their system resources in the manner provided by this invention.

The present invention allows an installation to selectively automate the management of a wide array of system resources for all or a selected set of work units in the system. The prior art did not allow for as granular a level of control over the resources managed nor the work units impacted by the management of these resources.

The present invention provides management over two types of resources. The first are system-wide resources that each have a limit that is cumulative for the entire system. An example of this type of a resource limit is MAXPROCSYS, which is the maximum number of processes in the system. The second type of resource managed is considered a process-related resource, where the resource limit applies to the utilization by a particular process. An example of this type of limit is MAXFILEPROC.

A process-related resource limit can be dynamically updated for a selected set of work units. In doing so, that limit is managed to the value specified by the installation for those work units only, without impact to any other work units in the system. This is particularly advantageous for managing resources for server processes and address spaces that may require distinct resource allocations that other processes in the system do not require.

The present invention provides the ability to automate the management of UNIX-related resources to an extent that is not possible in the prior art. In a preferred embodiment, for each system resource that is managed, threshold messages are displayed to the operator console warning when a resource is close its capacity. Each displayed message remains highlighted until the resource threshold is resolved. When a resource limit that is process-related is approached, the message displayed indicates which particular process and address space is involved and the current utilization level.

In addition, the present invention provides the operator with the capability to view the current utilization and high-water mark for each managed resource at a system level and the ability to view a given process's utilization and high-water usage for resources managed at a process level.

The present invention also provides the operator with the capability to dynamically update each system and process-related resource limit and for process-related resource limits the capability to select the work units to be impacted by the change.

Other systems allow for the dynamic update of system limits, but do not support the capability to selectively manage the limit for a particular address space or process in the system.

The functionality includes limits threshold messaging, limits high-water mark accounting and dynamic update capability for most UNIX System Services system limits. This functionality is provided in the disclosed embodiment via new operator console messages, new D OMVS commands, and new SETOMVS command functions. In particular, the new SETOMVS PID= function allows for the update of a UNIX System Services system limit, such as MAXPROCUSER, to impact only one process in the system.

### BRIEF DESCRIPTION OF THE DRAWINGS

FIG. 1 is a schematic block diagram of an information handling system incorporating the present invention.

FIG. 2A shows the procedure for processing a SETOMVS PID= command.

FIG. 2B shows the procedure for processing a SETOMVS LIMMSG= command.

FIG. 3 shows the procedure for processing a DISPLAY OMVS (D OMVS) command.

FIGS. 4A-4C show the procedure for generating threshold messages.

### DESCRIPTION OF THE PREFERRED EMBODIMENT

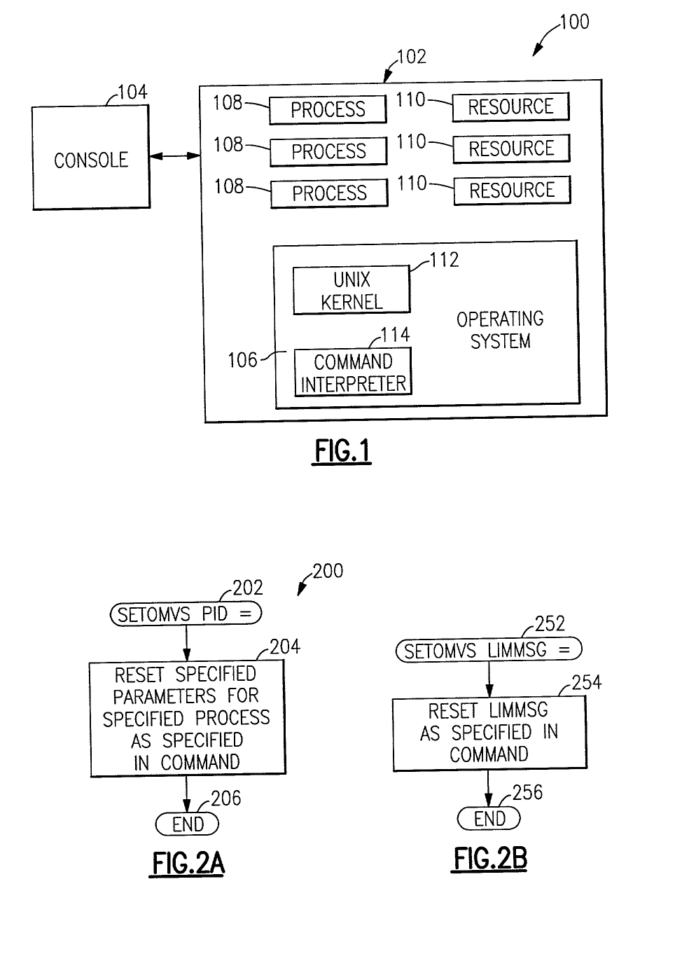

FIG. 1 is a schematic block diagram of an information handling system 100 incorporating the present invention. Information handling system 100 comprises a central processor complex (CPC) 102 to which an operator console 104 is attached. As is well known in the art, CPC 102 contains one or more central processors (CPs) as well as central storage for storing data currently being handled and programs currently being executed. Although not shown in FIG. 1, CPC 102 would typically be attached to various peripheral input/output (I/O) devices such as disk or tape drives, printers, communication networks and the like. Console 104 comprises an input device such as a keyboard for entering operator commands (such as the ones described below) as well as an output device such as a monitor for displaying messages or responses to commands. Console 104 may comprise a personal computer (PC) that is attached to CPC 102 either directly or through a service processor not separately shown. A command interpreter component 114 of OS 106 processes these operator commands to effect appropriate changes in the system and generate a response message for the operator. Messages that are generated by command interpreter 114 remain displayed on the monitor (in which case they are regarded as “current” or outstanding”) until they are deleted by the operator.

Although the disclosed embodiment uses a command-line interface in which commands are entered explicitly via a keyboard, other methods of entering commands—e.g., using a mouse and a graphical user interface (GUI)—could be used instead, and the term “command” is to be understood in this generalized sense. Similarly, while the disclosed embodiment displays text messages, graphical displays could be used as well, and the term “message” is to be understood in this generalized sense.

Executing on CPC 102 are one or more system images (one of which is shown), each of which comprises an operating system (OS) 106. Unless otherwise indicated, references to a “system” herein are to the system image corresponding to an OS 106. Each system image contains not only an OS 106, but also one or more processes 108 and one or more resources 110 whose usage is defined by a set of parameters described below. Although the invention is not limited to any particular platform, in the embodiment shown CPC 102 may comprise an IBM S/390 or eServer zSeries server, while OS 106 may comprise the IBM OS/390 or z/OS operating system. (zSeries and z/OS are recently introduced products having a 64-bit addressing mode; S/390 and OS/390 are predecessor products having 31-bit and 24-bit addressing modes.)

OS 106 has a UNIX System Services (USS) component 112 (depicted as the “UNIX kernel”0 in the figure) that performs UNIX functions for UNIX applications (not separately shown) executing on the system image; each of these applications may contain one or more of processes 108. As also noted below, and as is conventional in UNIX-based systems, each process 108 utilizing the services of the USS component 112 has a unique process identifier, or process ID (PID).

USS component 112 uses a set of parameters contained in a file referred to as a parmlib member to control its environment. These parameters relate to both the system as a whole and to individual processes 108 executing on the system. In the embodiment shown, system-wide parameters that are monitored by the present invention include the following:

| | |
|---|---|
| MAXPROCSYS | Specifies the maximum number of UNIX |
| | processes that the system allows. |
| MAXUIDS | Specifies the maximum number of UNIX |
| | user IDs (UIDs) that can operate |
| | concurrently. |
| MAXPTYS | Specifies the maximum number of |
| | pseudoterminals (pseudo-TTYs or PTYs) |
| | for the system. |
| MAXMMAPAREA | Specifies the maximum amount of data |
| | space storage space (in pages) that |
| | can be allocated for memory mappings |
| | of HFS files. |
| MAXSHAREPAGES | Specifies the maximum amount of shared |
| | system storage pages that UNIX functions |
| | can use. |
| IPCMSGNIDS | Specifies the maximum number of unique |
| | system-wide message queues. |
| IPCSEMNIDS | Specifies the maximum number of unique |
| | system-wide semaphore sets. |
| IPCSHMNIDS | Specifies the maximum number of unique |
| | system-wide shared memory segments. |
| IPCSHMSPAGES | Specifies the maximum number of |
| | system-wide shared pages created by |
| | calls to the fork( ) and shmat( ) functions. |
| IPCMSGQBYTES | Specifies the maximum number of bytes in a |
| | single message queue. |
| IPCMSGQMNUM | Specifies the maximum number of system-wide |
| | messages for each queue. |
| IPCSHMMPAGES | Specifies the maximum number of pages for |
| | shared memory segments. |
| SHRLIBRGNSIZE | Specifies the size of the shared library |
| | region for address spaces that load system |
| | shared library modules. |
| SHRLIBMAXPAGES | Specifies the number of data space storage |
| | pages that can be allocated for non-system |
| | shared library modules. |

In a similar manner, process-level parameters that are monitored by the present invention in the embodiment shown include the following:

| | |
|---|---|
| MAXFILEPROC | Specifies the maximum number of files that a |
| | single process can have concurrently active or |
| | allocated. |
| MAXFILESIZE | Specifies the maximum file size (in 4KB |
| | increments) that a process can create. |
| MAXPROCUSER | Specifies the maximum number of processes |
| | that a single UNIX user ID can have con- |
| | currently active, regardless of how the |
| | processes were created. |
| MAXQUEUEDSIGS | Specifies the maximum number of signals that |
| | UNIX allows to be concurrently queued within |
| | a single process. |
| MAXTHREADS | Specifies the maximum number of pthread_{—} |
| | created threads, including running, queued, and |
| | exited but undetached, that a single process |
| | can have concurrently active. |
| MAXTHREADTASKS | Specifies the maximum number of MVS tasks |
| | that a single process can have concurrently |
| | active for pthread_created threads. |
| IPCSHMNSEGS | Specifies the maximum number of attached |
| | shared memory segments for each address |
| | space. |
| MAXCORESIZE | Specifies the maximum core dump file size (in |
| | bytes) that a process can create. |

When a particular process has a shortage for one of these resources (i.e., the resource usage is approaching its limit), a message is displayed. So, a message for MAXFILEPROC shortage can be displayed for as many processes as there are in the system. When the particular processes shortage is relieved, then the message for that process will be deleted.

In the embodiment shown, the parmlib members of interest have names of the form BPXPRMxx, where xx represents a pair of alphanumeric characters. A particular such parmlib member, e.g. BPXPRM01, may comprise a listing of statements of the form:

MAXPROCSYS (400)

MAXPROCUSER (16)

MAXUIDS (200)

MAXFILEPROC (20)

.

.

.

In each statement, the value of the parameter appears in parentheses after the name.

When the system is started, the settings of a particular parmlib member (say, BPXPRM01) are put into effect. To dynamically change the parmlib member that is in effect, the operator enters the command:

SET OMVS=(xx)

where xx is the two-character suffix of the target parmlib member. Thus, if one wanted the settings of the parmlib member BPXPRM02 to take effect, one would enter the command:

SET OMVS=(02)

Further details of the operation of the operating system 106 and UNIX kernel 122 (including details relating the present invention) may be found in the IBM publications z/OS UNIX System Services Planning, GA22-7800-00 (March 2001); z/OS MVS Initialization and Tuning Reference, SA22-7592-00 (April 2001); z/OS MVS System Commands, SA77-7627-00 (March 2001); and z/OS MVS System Messages, Vol. 3 (ASB-BPX), SA22-7633-00 (March 2001), all of which publications are incorporated herein by reference.

### DISPLAY OMVS,LIMITS (D OMVS,L) Command

In accordance with one aspect of the present invention, a new operator command DISPLAY OMVS,LIMITS is used to display the system-wide or process-level resources, their current usage, their maximum (or high-water) usage, and the maximum values (or limits) that can set for those resources. In this command, the keywords D and L can be used as abbreviated alternatives to DISPLAY and LIMITS, respectively.

More particularly, in the embodiment shown, to display the system-wide parmlib limits, the operator enters the command:

OMVS,L

where D, OMVS, and L are fixed keywords. To reset the system-wide high-water marks to zero while doing this, the operator uses the additional keyword RESET:

D OMVS,L,RESET

Alternatively, to display the specific limits for a process, the operator enters the command:

D OMVS,L,PID=nnnnnnnn

where D, OMVS, L, and PID= are fixed keywordsand nnnnnnnn is the process ID (PID) of the process for which the information is being sought.

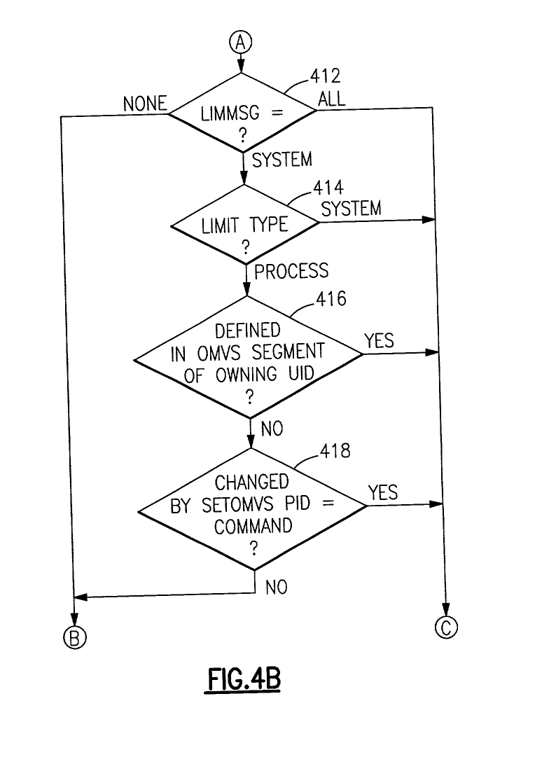

FIG. 3 shows the procedure 300 for processing a DISPLAY OMVS (D OMVS) command. In the embodiment shown, an operator would input the command using the keyboard of the operator console 102. Upon receiving such a command (step 302), the procedure 300 determines whether the command line contains the PID= keyword and therefore specifies a display for particular process 108 (step 304).

If the command line does not contain the PID= keyword, then the display is for the system as a whole, and the procedure 300 determines whether the command line contains the RESET keyword (step 306). If so, the procedure 300 first resets the high-water marks to zero (step 308). The procedure 300 then displays the limit (together with the current usage and high-water mark) for each system parameter, as shown below (step 310), before terminating (step 312).

If it is determined at step 304 that the command line does contain the PID= keyword, then the procedure 300 displays the limit (together with the current usage and high-water mark) for each process parameter for the process identified by the PID, also as shown below (step 314), before terminating (step 312).

Considering now a first example of the use of the D OMVS,L command, to display information about current system-wide parmlib limits, the operator enters the following command using the keyboard of the operator console 104:

DISPLAY OMVS,L

Upon execution of the command, the following message is displayed on the console monitor:

BPX0051I 14.05.52 DISPLAY OMVS 904

| OMVS 0042 ACTIVE | OMVS=(69) | | |
|---|---|---|---|
| SYSTEM WIDE LIMITS: | LIMMSG=SYSTEM | | |
| | | HIGH- | |
| | CURRENT | WATER | SYSTEM |
| | USAGE | USAGE | LIMIT |
| MAXPROCSYS | 1 | 4 | 256 |
| MAXUIDS | 0 | 0 | 200 |
| MAXPTYS | 0 | 0 | 256 |
| MAXMMAPAREA | 0 | 0 | 256 |
| MAXSHAREPAGES | 0 | 10 | 4096 |
| IPCMSGNIDS | 0 | 0 | 500 |
| IPCSEMNIDS | 0 | 0 | 500 |
| IPCSHMNIDS | 0 | 0 | 500 |
| IPCSHMSPAGES | 0 | 0 | 262144* |
| IPCMSGQBYTES | — | 0 | 262144 |
| IPCMSGQMNUM | — | 0 | 10000 |
| IPCSHMMPAGES | — | 0 | 256 |
| SHRLIBRGNSIZE | 0 | 0 | 67108864 |
| SHRLIBMAXPAGES | 0 | 0 | 4096 |

As is evident from the above depiction, the message contains a row for each system-wide resource being tracked. Each row in turn contains the name of the resource, the current usage, the high-water usage, and the system limit. In addition, the message contains such information as a message ID and the current values of the OMVS parameter (indicating which parmlib member BRXPRMxx is currently in effect) and the LIMMSG parameter (indicating the current display mode).

In the above message, an asterisk (*) displayed after a system limit indicates that the system limit was changed via a SETOMVS or SET OMVS= command.

In the embodiment shown, although IPCMSGQBYTES, IPCSMSGQMNUM, and IPCSHMMPAGES are displayed in the output of the D OMVS,L command, these resources are not monitored and no resource messages are issued.

The high-water usage column displays the highest value of this resource since initial program load (IPL) or the last use of RESET.

Considering now a second example of the use of the D OMVS,L command, to display information about current parmlib limits for a process with a PID of 33554434, the operator enters the following command using the keyboard of the operator console 104:

DISPLAY OMVS,L,PID=33554434

Upon execution of the command, the following message is displayed on the console monitor:

d omvs, 1 , pid=33554434
BPX0051I 14.06.49 DISPLAY OMVS 907

| OMVS | 0042 ACTIVE | OMVS=(69) | | |
|---|---|---|---|---|
| USER | JOBNAME ASID | PID | PPID | START |
| | | | STATE | |
| CT_SECS | | | | |
| WELLIE1 | WELLIE1 001C | 33554434 | 1 IRI | 14.04.38 |

| | |
|---|---|
| .015 | |
| LATCHWAITPID= | 0 CMD=EXEC |
| PROCESS LIMITS: | LIMMSG=SYSTEM |

| | CURRENT | HIGHWATER | PROCESS |
|---|---|---|---|
| | USAGE | USAGE | LIMIT |
| MAXFILEPROC | 0 | 1 | 256,1000 |
| MAXFILESIZE | — | — | NOLIMIT |
| MAXPROCUSER | 1 | 4 | 16 |
| MAXQUEUEDSIGS | 0 | 0 | 1000 |
| MAXTHREADS | 0 | 0 | 200 |
| MAXTHREADTASKS | 0 | 0 | 50 |
| IPCSHMNSEGS | 0 | 0 | 10 |
| MAXCORESIZE | — | — | 4194304, |
| | | | NOLIMIT |

This display is similar to the one for system-wide limits, with the resources displayed being process-level resources rather than system-level resources as before

In the embodiment shown, although MAXFILESIZE and MAXCORESIZE are displayed in the output, their current and high-water usage are not monitored, and no resource messages are issued for these resources.

In addition, MAXCORESIZE, MAXFILESIZE, and MAXCORESIZE each have hard and soft limits. When the hard and soft limits are the same, only one value is displayed. When the limits are different, both values are displayed: first the soft limit and then the hard limit, separated by a comma. In the preceding example, MAXFILEPROC has a hard limit of 1000 and a soft limit of 256. For MAXFILESIZE, the soft limit is equal to the hard limit and is unlimited. For MAXCORESIZE, the soft limit is 4,194,304 and the hard limit is unlimited.

In the above message, an asterisk displayed after a process limit indicates that the limit was changed, either directly, with a SETOMVS,PID= command; or indirectly, by a global change of this value with a SETOMVS command. Thus, if the SETOMVS command is issued to change the value of MAXFILEPROC to 256, the information displayed is:

| | CURRENT | HIGHWATER | PROCESS |
|---|---|---|---|
| | USAGE | USAGE | LIMIT |
| MAXFILEPROC | 0 | 0 | 256* |
| . | | | |
| . | | | |

If the process then changes its soft limit for MAXFILEPROC to 100, the information displayed is:

| | CURRENT | HIGHWATER | PROCESS |
|---|---|---|---|
| | USAGE | USAGE | LIMIT |
| MAXFILEPROC | 0 | 0 | 100,256 |
| . | | | |
| . | | | |
| . | | | |

### SETOMVS Command

In the embodiment shown, the SETOMVS command is used to change dynamically the options that the UNIX System Services component 112 currently is using. These options are originally set in the BPXPRMxx parmlib member at the time of initial program load (IPL) of the system. Further information on the BPXPRMxx parmlib member may be found above as well as in the publication z/OS UNIX System Services Planning referred to previously.

Changes to all of the system-wide limits take effect immediately. When a process limit is updated, all processes that are using the system-wide process limit have their limits updated. All process limit changes take effect immediately, except for those processes with a user-defined process limit (defined in the OMVS segment or set with a SETOMVS PID= command). An exception is MAXASSIZE and MAXCPUTIME, which are not changed for active processes.

The command changes will take more immediate effect for more of the system limits. This will eliminate the need for an installation to have to recycle an application to pickup a new limit. Also, the process level resources can be changed for a specific process, allowing an installation to give some processes more use of resources while limiting resource usage for others.

This support will allow an installation to react quickly when UNIX System Services resources are reaching critical levels to prevent application outages.

The general syntax of the SETOMVS command, which is an existing MVS system command, is as follows:

SETOMVS parameter_name=parameter_value

where parameter_name is the name of the parameter being set and parameter_value is the value to which it is being set. Thus, to change MAXPROCSYS to 100, the operator would enter the command:

SETOMVS MAXPROCSYS=100

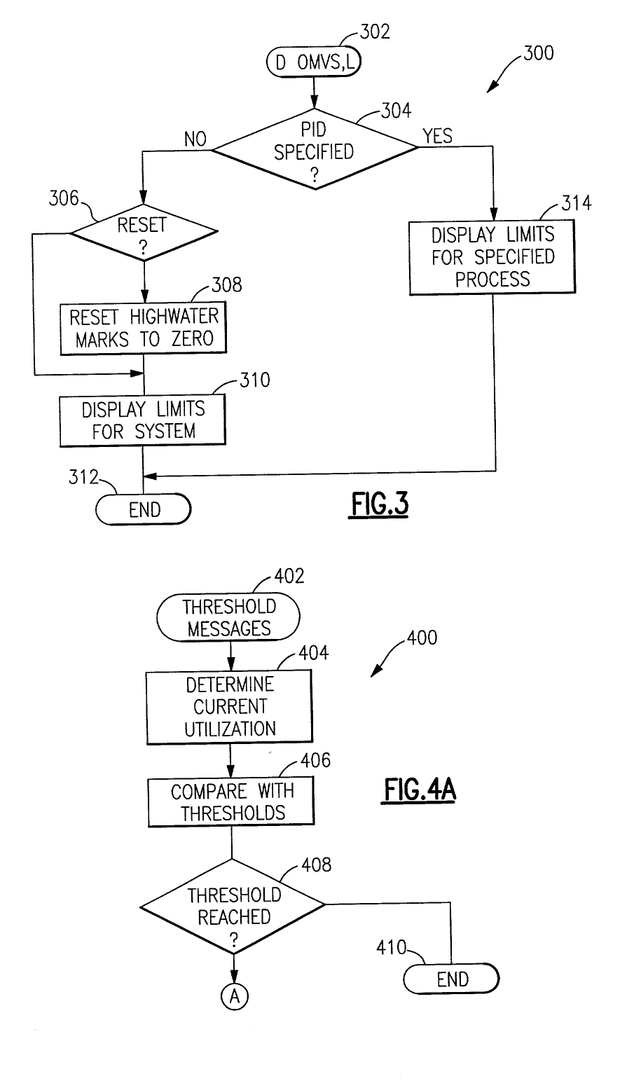

In accordance with the present invention, the SETOMVS command is used to change the value of a parameter only for a particular process, without changing its value for other processes, by setting a process parameter PID equal to the PID of the target process. FIG. 2A shows the general procedure 200 for processing a SETOMVS PID= command. Upon receiving such a command (step 202), the procedure 200 resets the specified parameters for the process 108 specified by the PID= keyword to the values specified in the command line (step 204) before terminating (step 206).

Thus, to change MAXFILEPROC only for the process identified by the process ID 5 to 200, the operator would enter the command:

SETOMVS PID=5, MAXFILEPROC=500

In accordance with the present invention, the SETOMVS command is also used to control the automatic display of messages as particular parameter values cross thresholds by setting a limit message parameter LIMMSG to be ALL, NONE, or SYSTEM. FIG. 2B shows the general procedure 250 for processing a SETOMVS LIMMSG= command. Upon receiving such a command (step 252), the procedure 250 resets the LIMMSG parameter to the value specified in the command line (step 254) before terminating (step 256).

Thus, to display all such messages, the operator enters the command:

SETOMVS LIMMSG=ALL

Similarly, to suppress the display of all such messages, the operator enters the command:

SETOMVS LIMMSG=NONE

Finally, to display only certain messages (primarily system messages), the operator enters the command:

SETOMVS LIMMSG=SYSTEM

If the LIMMSG statement is specified with SYSTEM or ALL, a warning console message appears whenever a limit reaches 85%, 90%, 95%, and 100%; identifying the process that has reached the limit. As the limit reaches the next limit level, the prior message is removed from the console and a new message is displayed indicating the new limit level that has been reached. When the limit falls below the 85% threshold, a message is issued indicating that the resource shortage has been relieved.

Changing from LIMMSG(ALL) or LIMMSG(SYSTEM) to LIMMSG(NONE) with the SETOMVS command stops any further monitoring of resources. However, existing outstanding messages are not deleted from the screen for a process until the limit is relieved for that process.

### Resource Monitoring

As noted above, in addition to operator commands to set and display resource usage, there is also monitoring of these resources and warnings issued when a resource reaches a critical level. The installation can choose to see these warnings for system level resources, for process level resources for a particular process, or for all resources. This allows an installation to choose which processes it wants to allocate resources to.

As already indicated, messages are issued as the parmlib values reach 85%, 90%, 95% and 100% of their current limit. Messages are also issued as the usage decreases and then when the usage goes below 85% again. These messages stay on the operator console until the usage decreases or the operator deletes them.

The following are examples of system-level messages:

| | |
|---|---|
| BPXI039I | SYSTEM LIMIT MAXPROCSYS HAS REACHED yyy% |
| | OF ITS CURRENT CAPACITY OF XXX |
| BPXI042I | RESOURCE SHORTAGE FOR MAXPROCSYS HAS BEEN |
| | RELIEVED |

The following are examples of process-level messages:

| | |
|---|---|
| BPXI040I | PROCESS LIMIT MAXFILEPROC HAS REACHED xxx% |
| | OF ITS CURRENT CAPACITY OF yyy FOR PID=nnnnnnnn |
| | IN JOB jobname RUNNING IN ADDRESS SPACE aaaa |
| BPXI041I | RESOURCE SHORTAGE FOR MAXFILEPROC FOR |
| | PID=nnnnnnnn HAS BEEN RELIEVED |

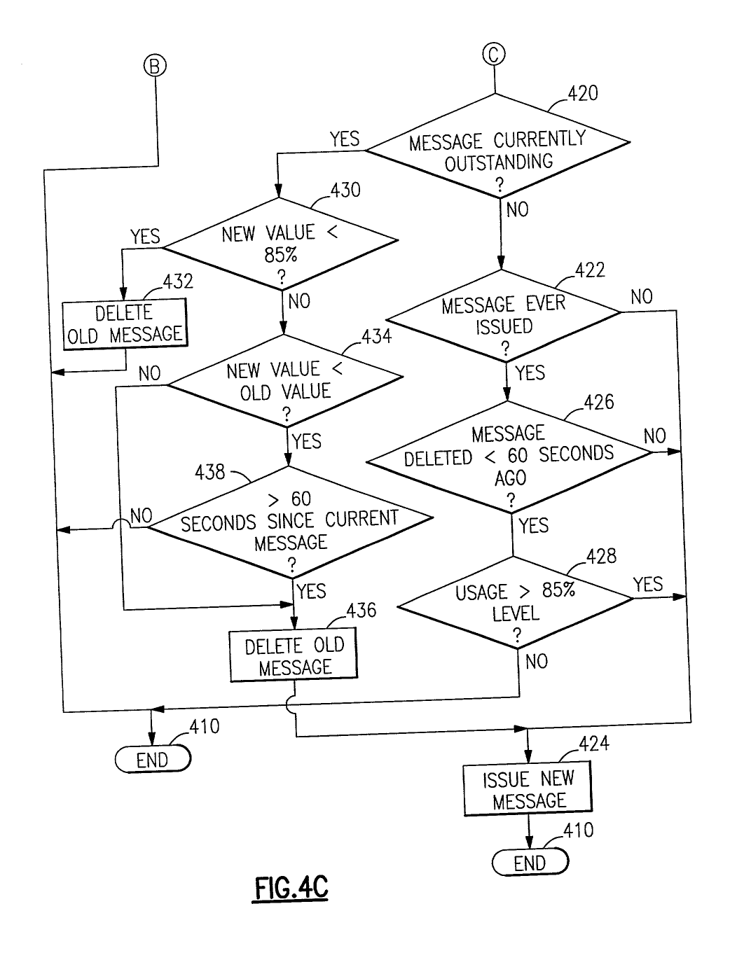

FIGS. 4A-4C show the procedure 400 used to determine when to issue a message. The procedure 400 is invoked periodically (step 402) for each system or process usage value being monitored. For each such invocation, the procedure 400 determines the current resource utilization (step 404) and compares it with the thresholds established for that resource (step 406) to determine whether a threshold event has occurred (step 408). In the embodiment shown, such an event is deemed to have occurred when a system or process parameter being monitored has reached a predetermined threshold (85%, 90%, 95%, and 100% in the embodiment shown). If no such threshold event has occurred, the procedure 400 terminates for that iteration for the resource (step 410)

If at step 408 it is determined that a threshold event has occurred, the procedure 410 then examines the setting of the parameter LIMMSG (step 412). If LIMMSG=NONE, then the procedure 400 simply terminates and no message is issued (step 410). If, on the other hand, LIMMSG=ALL, then the procedure 400 advances to step 420, described below.

If LIMMSG=SYSTEM, then the action depends on the type of limit operating on the parameter (step 414). If the limit is a system limit, then the procedure 400 advances to step 420 as it did for LIMMSG=ALL. If the limit is a process limit, and if it is defined in the OMVS segment of the owning user ID (step 416) or has been changed with a SETOMVS PID= command (step 418), then the procedure 400 likewise advances to step 420 as it did for LIMMSG=ALL. For any other process limit with LIMMSG=SYSTEM, the procedure 400 simply terminates and no message is issued (step 410).

At step 420, the procedure 400 determines whether any message for the particular resource is currently outstanding, i.e., has been issued but not deleted so that it remains on the display of the operator console 104.

If at step 420 there is no message currently outstanding for a resource, and if no message was ever previously issued for that resource (threshold is zero) (step 422), then a new message is issued (step 424) before terminating (step 410). If at step 422 there was a message previously issued, and if the message was deleted less than 60 seconds ago (step 426) and the usage is at the lowest threshold value (85%) (step 428), then the procedure 400 terminates without issuing a new message (step 410). Alternatively, if the message was deleted less than 60 seconds ago (step 426) or the usage has already jumped past the 85% level (step 428), then a new message is issued (step 424) before terminating (step 410).

If at step 420 a message is currently outstanding, and the new value is below the low threshold of 85% (step 430), then the old message is simply deleted (step 432) and the procedure 400 terminates without issuing a new message (step 410). If the new value is greater than the old value (step 434), the old message is deleted (step 436) and a new one is issued (step 424) before terminating (step 410). If at step 434 the new value is less than the old value, and more than 60 seconds has elapsed since the current message was issued (step 438), then the old message is likewise deleted (step 436) and a new one issued (424) before terminating. If at step 438 less than 60 seconds has elapsed since the current message was issued, then the procedure 400 simply terminates without issuing a new message (step 410).

While a particular embodiment has been shown and described, various modifications will be apparent to those skilled in the art. Thus, while the operator interface is described as being a command line interface in which the operator enters commands via a keyboard, a graphical user interface (GUI) using a mouse or the like could also be used. Similarly, while the commands are described as being entered manually by the operator, the injection of such commands into the system could be automated, using scripts and the like, if desired. In addition, the present invention could be used to control parameters other than the ones described, as well as those in non-UNIX-based systems.

What is claimed is:

1. In an information handling system in which one or more processes executing on said system are utilizing a resource, a method for managing said resource comprising the steps of
determining a current utilization of said resource;
comparing said current utilization of said resource with a predetermined maximum utilization set for said resource; and
generating a message if said current utilization of said resource reaches a predetermined threshold relative to said predetermined maximum utilization set for said resource.

2. The method of claim 1 in which said current utilization and said predetermined maximum utilization are determined for the system as a whole.

3. The method of claim 1 in which said current utilization and said predetermined maximum utilization are determined for a particular process executing on said system.

4. The method of claim 1 in which said message is generated if said current utilization of said resource reaches a predetermined fraction of said predetermined maximum utilization set for said resource.

5. The method of claim 1 in which a message is generated if said current utilization of said resource reaches any one of a plurality of predetermined thresholds relative to said predetermined maximum utilization set for said resource.

6. The method of claim 1, comprising the further step of selecting one of a plurality of display modes in which different subsets of messages are displayed.

7. The method of claim 6 in which the display mode is selected in response to an operator command.

8. In an information handling system in which a plurality of processes executing on said system are utilizing a resource, a method for managing said resource comprising the steps of:
receiving an external command specifying a maximum utilization of said resource by a specified one of said plurality of processes; and
in response to said command, setting said maximum utilization of said resource by said specified one of said plurality of processes as specified by said command, independently of any other of said plurality of processes executing on said system.

9. In an information handling system in which a plurality of processes executing on said system are utilizing a resource, a method for managing said resource comprising the steps of:
receiving an external command for the display of the current utilization of said resource by a specified one of said plurality of processes;
in response to said command, generating a display of the current utilization of said resource by said specified one of said plurality of processes.

10. The method of claim 9 in which said plurality of processes utilize a plurality of resources, said display showing the current utilization of each of said resources by said specified one of said plurality of processes.

11. The method of claim 9 in which said display also shows a predetermined maximum utilization set for said resource.

12. The method of claim 9 in which said display also shows a maximum actual utilization of said resource over a predetermined period.

13. In an information handling system in which one or more processes executing on said system are utilizing a resource, apparatus for managing said resource comprising:
means for determining a current utilization of said resource;
means for comparing said current utilization of said resource with a predetermined maximum utilization set for said resource; and
means for generating a message if said current utilization of said resource reaches a predetermined threshold relative to said predetermined maximum utilization set for said resource.

14. The apparatus of claim 13, further comprising means for selecting one of a plurality of display modes in which different subsets of messages are displayed.

15. In an information handling system in which a plurality of processes executing on said system are utilizing a resource, apparatus for managing said resource comprising:
means for receiving an external command specifying a maximum utilization of said resource by a specified one of said plurality of processes; and
means responsive to said command for setting said maximum utilization of said resource by said specified one of said plurality of processes as specified by said command, independently of any other of said plurality of processes executing on said system.

16. In an information handling system in which a plurality of processes executing on said system are utilizing a resource, apparatus for managing said resource comprising:
means for receiving an external command for the display of the current utilization of said resource by a specified one of said plurality of processes;
means responsive to said command for generating a display of the current utilization of said resource by said specified one of said plurality of processes.

17. A program storage device readable by a machine, tangibly embodying a program of instructions executable by the machine to perform method steps for managing a resource in an information handling system in which one or more processes executing on said system are utilizing said resource, said method steps comprising:
determining a current utilization of said resource;
comparing said current utilization of said resource with a predetermined maximum utilization set for said resource; and
generating a message if said current utilization of said resource reaches a predetermined threshold relative to said predetermined maximum utilization set for said resource.

18. The program storage device of claim 17, said method steps further comprising the step of selecting one of a plurality of display modes in which different subsets of messages are displayed.

19. A program storage device readable by a machine, tangibly embodying a program of instructions executable by the machine to perform method steps for managing a resource in an information handling system in which a plurality of processes executing on said system are utilizing said resource, said method steps comprising:
receiving an external command specifying a maximum utilization of said resource by a specified one of said plurality of processes; and
in response to said command, setting said maximum utilization of said resource by said particularspecified one of said plurality of processes as specified by said command, independently of any other of said plurality of processes executing on said system.

19. A program storage device readable by a machine, tangibly embodying a program of instructions executable by the machine to perform method steps for managing a resource in an information handling system in which a plurality of processes executing on said system are utilizing said resource, said method steps comprising:
receiving an external command for the display of the current utilization of said resource by a specified one of said plurality of processes;
in response to said command, generating a display of the current utilization of said resource by said specified one of said plurality of processes.
